(19) United States
(12) Patent Application Publication
(10) Pub. No.: US 2013/0028047 A1
(43) Pub. Date: Jan. 31, 2013

(54) BOTTOM MODULE FOR SEISMIC SURVEY

(71) Applicants: Yury Georgievich Erofeev, Murmansk (RU); Aleksandr Dmitrievich Ivanenko, Murmansk (RU); Mikhail Arkadievich Voronov, Sertolovo (RU); Yury Viktorovich Roslov, St. Peresburg (RU)

(72) Inventors: Yury Georgievich Erofeev, Murmansk (RU); Aleksandr Dmitrievich Ivanenko, Murmansk (RU); Mikhail Arkadievich Voronov, Sertolovo (RU); Yury Viktorovich Roslov, St. Peresburg (RU)

(21) Appl. No.: 13/493,041

(22) Filed: Jun. 11, 2012

(30) Foreign Application Priority Data
Jul. 28, 2011 (RU) RU2011131517/28

(51) Int. Cl. G01V 1/38

(52) U.S. Cl. 367/20

(57) ABSTRACT

A system is proposed for conducting efficient marine seismic surveys in different climatic conditions for water depths of 0-500 meters, in near-shore zones and on the land for obtaining seamless profiles. The system includes at least one bottom module (BM) and onboard devices located on a vessel. The BM can be submerged from the vessel onto a bottom ground and lifted up on the board. The BM includes a case provided with roundings on its upper surface and its bottom area, to which case are mounted damping elements, a hydrophone and a geophone block for receiving seismic data, a vacuum port, a hermetic electrical socket, and equipment arranged inside the case, including—a clock generator,—a digital compass providing angle data,—an interface board essentially reading the seismic and angle data and transmitting thereof to the onboard devices, and—a recorder board communicating with the geophones, hydrophone, and interface board.

### CROSS-REFERENCE TO RELATED APPLICATION

This U.S. patent application claims priority under 35 U.S.C. 119 (a) through (d) from a Russian Federation patent application No. 2011131517/28 filed on 28 Jul. 2011 hereby entirely incorporated by reference.

### FIELD OF THE INVENTION

The invention relates to marine self-contained bottom modules of seismic stations designed for seismic acquisition in different climatic conditions in water areas with depths from 0 up to 500 meters, in transition zones and for obtaining a seamless profile.

### BACKGROUND OF THE INVENTION

In the related art, there are known seismic bottom systems (see List of References 1-3 herein below) typically mounted at the bottom of a water reservoir, wherein such system usually comprises an underwater (submergible) module and an onboard module. The underwater module usually includes a hermetic case provided with a submerging subsystem; the case contains equipment for registering hydro-acoustic signals, which equipment includes appropriate filters, formers, converters, data storage devices, synchronization circuitry, a power supply unit, and a device for orientation of the underwater module.

The underwater module is associated with a tubular support frame bearing a block of measurement sensors capable of measuring the vibrations (oscillations) of soil of the water reservoir bottom. The module is also furnished with metal unfolding mechanisms for depressing (clasping) thereof against the bottom ground. Due to the depression, a border metal-ground zone is formed in the place of contact of the unfolding mechanisms and the ground.

A main disadvantage of the above-mentioned bottom modules is the impossibility of transferring the ground vibrations to the measurement sensors without distortion. The unfolding mechanisms in combination with the metal-ground zone cause signal noises while the acoustic signals are travelling therethrough that finally results in erroneous measurements.

Moreover, the use of the unfolding mechanisms is inefficient because of their complexity, the absence of control of the mechanisms during deployment thereof, which sometimes causes the block of measure sensors getting into the loose ground, and, as a consequence, significantly worsens the operability of the bottom station.

There is known a marine self-contained bottom seismic system (Reference 4), having a ballast anchor made in the form of a concrete disk or a rectangular parallelepiped with a hemispheric cavity for installation of the underwater unit with its fixation by releasable fasteners that provides for a larger contact area of the ballast with the ground and with the unit case, which, in turn, provides for a better transfer coefficient of seismic vibrations at the border zones between the ground and the anchor, and between the anchor and the measure sensors.

The disadvantage of such a device is that, during deployment on a rough ground, in presence of near-bottom water streams, the ballast anchor doesn't ensure a proper engagement of the underwater unit with the ground, that leads to swaying the underwater unit and generating an acoustic noise in water due to appearance of a turbulent mode of the water streams flowing around the underwater unit. This process can negatively affect operation of receivers of seismic signals, which are orientation sensitive.

There is known a bottom system module for seismic survey and seismic monitoring (Reference 6), wherein for ensuring the operability of vertical and horizontal seismic signal receivers, they are oriented with the help of a gimbal suspension. However, such structure essentially complicates arrangement of measure sensors inside the module, taking into account its small dimensions. Besides, in such a module, the total mass of measuring equipment and the module case significantly increases that leads to using complicated technical solutions for providing positive floatage at emerging of the bottom module after disconnection of the anchor for processing the registered data by the onboard module.

Installation of the gimbal suspension requires fixing elements for attachment thereof to the inner surface of the module case that increases the module's mass and size, and complicates guaranteeing the condition that the point of application of the elevating force should be situated higher than the center of gravity of the module during emerging thereof. The gimbal suspension can also be a source of extra noises at the seismic signal transfer to the measurement sensors because of its own natural oscillation frequencies.

There is also known a bottom module for seismic survey and seismic monitoring, which is considered as the nearest related art device, herein called a ‘prototype’ that comprises a hermetic case consisting of two hemispheres provided with a joint O-ring in the place of connection. The prototype bottom module contains geophysical equipment including: measurement geophone sensors and hydrophones; a control and registration unit including components for receiving, recording, conversion, and storage of registered signals, which control and registration unit is controlled by a computer processor; interface units for interfacing with external devices, including the onboard module, during the emerging of the module; satellite and hydro-acoustic communication channels; an orientation unit; a synchronization unit; a self-release control unit; and a power supply unit.

On the outer surface of the case there are mounted: hydro-acoustic and satellite antennas; means for search of the bottom module at emerging; tackle elements and connectors; and a device for ground installation of the module designed in the form of an anchor ballast (RU2294000). The aforesaid module has the following disadvantages: a limited range of use in the near-shore zone and in shallow waters; and complexity of forming a seamless seismic section on the boarder of land and adjacent shelf areas.

### BRIEF DESCRIPTION OF THE INVENTION

The primary aim of the present invention is to extend the range of use of seismic bottom stations (also called bottom systems), particularly, in the near-shore zone, on shallow waters, and on the land. Other aims may become apparent to a skilled artisan upon learning the present disclosure.

The technical results achieved by the invention are: an extension of the range of use of seismic bottom systems; enabling the formation of a seamless seismic section on the boarder of land and adjacent shelf areas; an enhanced noise protection; a reduction of laboriousness for manufacturing the bottom systems; and an improved usability of the bottom systems.

The aforesaid results are achieved by providing a seismic survey system including a number of onboard devices and at least one underwater module (herein also called an inventive ‘bottom module’), wherein, in a preferred embodiment, the bottom module comprises: a hermetic case assembled of two hemispheres, supplied with a seal joint O-ring mounted in the place of connection of the two hemispheres; an external hydrophone mounted on the outer surface of the hermetic case; a number of blocks for interface with the onboard module; an orientation block; a number of tackle elements and connectors; a power supply unit (also called a ‘power unit’) placed inside the hermetic case; and geophysical equipment placed inside the hermetic case; wherein the geophysical equipment includes: a block of geophones (geophone block), a digital compass, a recording and control unit including components for receiving and recording seismic signals; a conversion unit for conversion and storage of the recorded seismic signals, including an ADC (analog-digital converter) component, a computer processor, and a memory component.

According to a preferred embodiment of the present invention, the inventive bottom module additionally comprises: a hermetic electrical socket for connection to the external devices and the onboard module, the hermetic electrical socket is mounted on the outer surface of the bottom module, and capable of charging rechargeable batteries of the power supply unit therethrough; a vacuum port mounted on the outer surface of the bottom module, useable for pumping out air from the inner space of the hermetic case; a digital compass placed inside the hermetic case; wherein the recording and control unit includes a recorder board and an interface board linked with one another by multiplex communication channels controlled by microcontrollers and connected with a clock signal generator; the recorder board is connected with the geophones by multiplex communication channels; the digital compass is connected with the interface board; the clock signal generator is connected via multiplex (interface and local) communication channels with the geophone block; and wherein the interface board is connected with the power supply unit, and the recorder board is connected with the external hydrophone.

The bottom module can be additionally supplied with an outside positioned indicator unit, connected with the interface board. The indicator unit is formed to be capable of indicating the current state of the bottom module, i.e. its readiness for operation that allows the operator to estimate the operability of the bottom module without opening thereof and extra testing the equipment functionality, as well as to make a decision on deployment of the bottom module on a seismic profile, or on the necessity of performing any actions for deployment of the bottom module. Thus, the indicator unit helps improving the convenience of use of the bottom module, enhances productivity, and significantly reduces the risk of error at conducting the measurements, which error might be caused by inoperability of the bottom module.

The recorder board has four separate identical communication channels for connection with the geophone block and the hydrophone, whereas the geophone block and the external hydrophone are also connected via multiplex communication channels with a multifunctional chip including a programmable analog amplifier and an analog-digital converter (herein also called an ADC unit). The programmable amplifier may additionally include a preliminary amplifier installed in the corresponding communication channel connected with the external hydrophone and capable of extra pre-amplifying the hydrophone signal, and also capable of selecting and storing the gain coefficient for every channel.

The recorder board can be additionally supplied with a the digital low-frequency filter represented by a chip, having an input port connected with an output port of the ADC unit, and having an output port connected with a microcontroller, capable of conversion of bit sequences of the seismic data, received via every channel from the geophones and the external hydrophone, into a byte-page format, with further recording thereof into the memory unit, and also providing the time synchronization of operation of the components of the recorder board with the clock signal generator.

The interface board comprises a programmable microcontroller, having an internal memory; the interface board is capable of:—receiving, processing, and storage in the internal memory of angle parameters outputted from the digital compass;—indicating the state of system upon an operator's request;—control of the state of the power supply unit and of the process of recharging the batteries of power supply unit through the electric hermetic connector;—reading the seismic data from the internal memory and transferring thereof through a high-speed channel to external computer devices and memory devices; and—switching the module into a low power consumption mode during the seismic survey.

The recorder board is capable of receiving, processing, and recording the seismic vibrations that can be represented by four components: X, Y, Z components received from the geophones being an orthogonal right-hand system with corresponding axes, and an H-component received from the hydrophone, thereby providing a registration of both the longitudinal and transversal waves, wherein the X axis is associated with the digital compass for determination of the orientation of the bottom station's coordinates during installation thereof on a seismic profile.

In a preferred embodiment of the invention, the hermetic case of the bottom module is formed as a cylindrical watertight case with a bulging upper lid and a radial rounding of the cylindrical lateral surface made in the area adjacent to the cylinder's flat bottom, providing a minimization of noises appearing due to sea streams flowing around the bottom module. The case comprises damping elements placed on the outer lateral surface thereof, and providing for protection from mechanical impacts of the module's external elements projecting beyond the case.

The bottom module is capable of transformation for operation on an icy surface with remote hydrophones, which remote hydrophones should be installed into holes punched in the ice.

### BRIEF DESCRIPTION OF DRAWINGS OF THE INVENTION

FIG. 1 represents a vertical sectional view of the bottom module, according to an embodiment of the present invention.

FIG. 2 represents a horizontal sectional view of the bottom module, according to the embodiment of the present invention shown in FIG. 1.

FIG. 3 represents a functional flowchart of measurement and control equipment of the bottom module, according to an embodiment of the present invention.

It must be noticed, however, that the aforesaid drawings depict only typical design variants of the invention, and therefore cannot be regarded as limitations of the invention, which may also include other equally effective design variants.

### DESCRIPTION OF PREFERRED EMBODIMENTS

While the invention may be susceptible to embodiment in different forms, there are shown in the drawings, and will be described in detail herein, specific embodiments of the present invention, with the understanding that the present disclosure is to be considered an exemplification of the principles of the invention, and is not intended to limit the invention to that as illustrated and described herein.

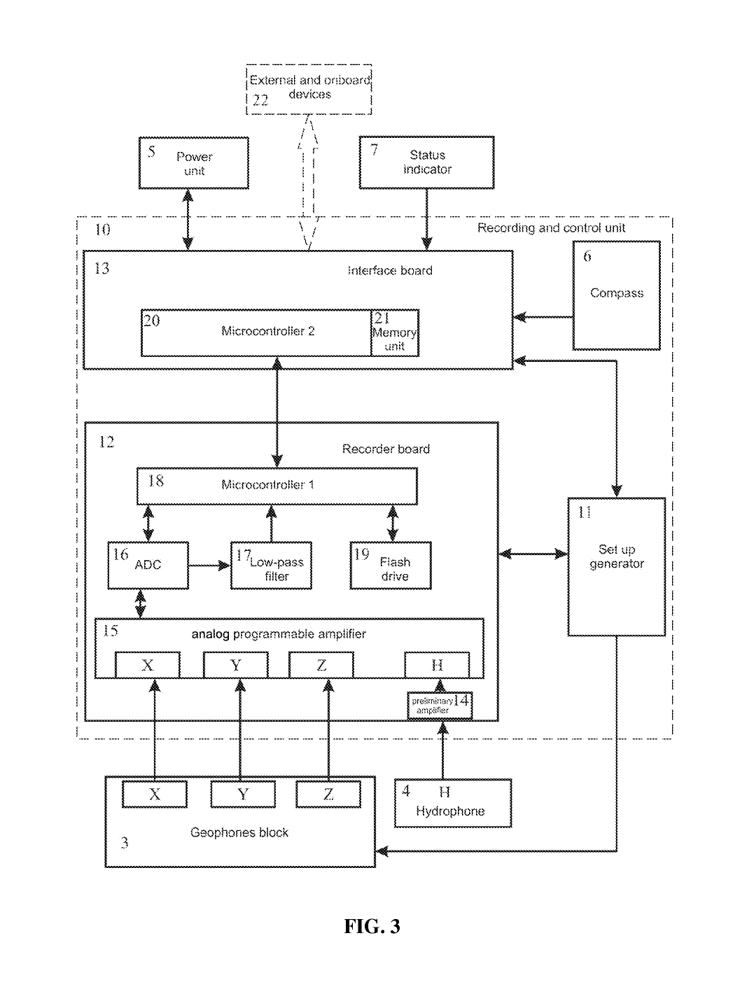

As shown on the functional flowchart (FIG. 3), the equipment of bottom module comprises: geophysical sensors consisted of a geophone block 3 (including geophones of three channels, denoted as X, Y, and Z) and a hydrophone 4; a recording and control unit 10, including a recorder board 12 and an interface board 13 under control of microcontrollers 18 and 20 correspondingly, wherein the recorder board 12 includes a programmable analog amplifier 15, an ADC (analog-digital converter) unit 16, a low-frequency filter unit 17, and a flash memory drive unit 19; a clock signal generator 11 (herein also called a ‘set up generator’) connected with the recorder board 12, the interface board 13, and the geophone block 3; a digital compass 6 connected with the interface board 13; a registration unit (not shown on FIG. 3); an indicator unit 7 connected with the interface board 13; a vacuum port 9 (being a hole of a predeterminedly small diameter in the case 1, closed with a cover plug, not illustrated); a GPS unit (not shown on FIG. 3); a synchronizer (not shown on FIG. 3); and a power supply unit 5.

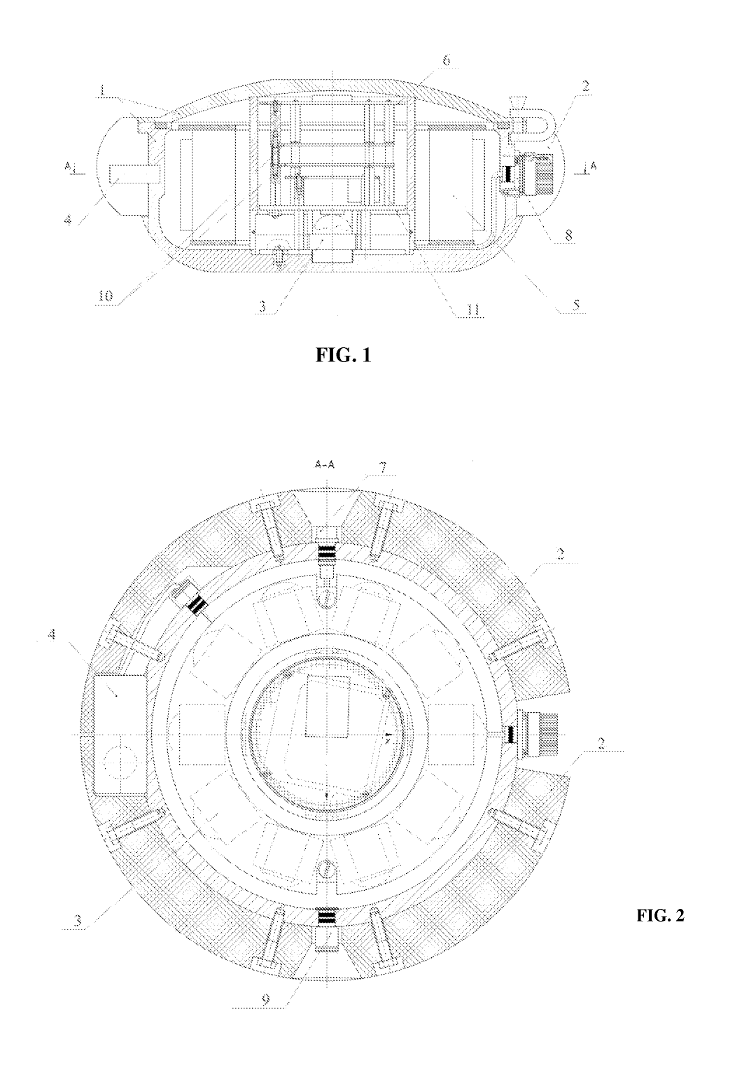

The bottom module (FIGS. 1 and 2) comprises a compact cylindrical hermetic case 1 (herein also called a ‘case’ of the bottom module) with a bulging upper lid and a radial rounding of the cylindrical side surface in the area adjacent with the flat bottom of the cylinder. The case 1 encapsulates the following equipment: the power supply unit 5; the recording and control unit 10, including the digital compass 6, and also the geophone block 3. The hydrophone 4, the electric hermetic connector 8, and the status indicator 7 are installed outside of the hermetic case 1, whereas the vacuum port 9 is built into the case 1.

The hermetic case 1 is made of metal providing operability of the bottom module in severe exploitation conditions and comprises rigging (tackle) devices intended for transportation of the bottom module, and installation thereof on the seabed (bottom ground) with the help of a halyard. According to preferred embodiments of the invention, the bottom module has a negative floatage. The external equipment elements projecting beyond the case 1 (e.g. the hydrophone 4) are protected by special damping elements 2, made, for example, of plastic or rubber. The compact shape of the bottom module's case and streamlining at the flat bottom provides minimization of noises caused by sea streams flowing around the bottom module.

The material of the module case, its design, and the arrangement of equipment therein are developed taking into account minimization of influence thereof upon operation of the digital compass 6. At that, the bottom module should be designed to allow for carrying thereof by one hand of an average person. The bottom module should also be designed to allow for deployment thereof in a temperature range from −20° C. to +50° C.

The geophone block 3 is intended for:—receiving of elastic waves, travelling in the earth crust, measuring three components of a displacement vector {X,Y,Z}: a vertical Z-component and two mutually perpendicular horizontal X,Y-components; and—for conversion of ground seismic vibrations into electric signals. In a preferred embodiment, the geophone block 3 is implemented in the form of a right-hand orthogonal triplet of geophones GS-20DX having an input signals frequency range of from 10 to 250 Hz and a sensitivity of 27 V/m/s. The X axis of the right-hand orthogonal system is associated with readings of the digital compass 6 for determining the orientation of the bottom module's coordinates and the entire seismic system during the installation and deployment thereof on a seismic profile. The digital compass 6 measures the angle values of the bottom module with a pre-set period of time. The digital compass 6 is rigidly fixed on a plate with a number of peripheral orifices receiving screws, which allows positioning the plate with a step of 5 degrees. Therefore, the positions of the geophone's X-axis and the compass' axis are known. When the compass 6 is mounted on the bottom module, these two axes are coincided that enables getting additional information about seismic vibrations in the researched profile during the processing of the seismic data jointly with the orientation angles. In preferred embodiments, during the use of the bottom module for engineering seismic surveys, for example, by known methods of refracted and reflected waves, an operative change of the geophone block can be provided.

The interface board 13, illustrated on FIG. 3, comprises a programmable microcontroller 20, associated with an internal memory unit 21 (also called a second memory unit). The microcontroller 20 is substantially capable of receiving, processing, and storage into the internal memory unit 21 of values of measured angles, received from the output of digital compass 6. The microcontroller 20 is also capable of—indicating the state of system upon an operator's request through the status indicator 7;—control of the state of the power supply unit 5 and of the process of recharging the batteries of power supply unit 5 through the electric hermetic connector 8;—control of reading the seismic data from the compass 6 into the internal memory unit 21 and transferring the seismic data through a high-speed channel to external computer devices 22; and—switching the module into a low power consumption mode during the seismic survey.

The hydrophone 4 is intended for receiving of sonic and ultrasonic waves travelling in the water environment. It can be implemented as any known type of hydrophones, for example, operating in a frequency range of from 2 to 100 Hz, and having a sensitivity of at least 25 microV/Pa.

The power supply unit 5, for example, may comprise two parallel lines (for increasing the work autonomy), having 5 sequentially connected rechargeable batteries in each line, providing a total voltage of about 7V. The charging of the power supply unit 5 is conducted without opening the hermetic (leak-proof) case 1 through the electric hermetic connector 8.

In a preferred embodiment of the invention, connection of the external devices and onboard devices 22 to the bottom module is provided through the electric hermetic connector 8, externally mounted on the module's case 1 and protected with the damping elements 2 during operation of the bottom module on seismic surveys.

The registration unit (not shown on FIGS. 1-3) is intended for registration of two kinds of information: the seismic data and the spatial positioning of the bottom module. It includes a carcass supporting a number of recorder elements for recording the above mentioned seismic and module positioning data. Ni-MH-rechargeable batteries (not shown on FIGS. 1, 2, and 3) can be used for power supply of the registration unit, providing an autonomous operation in a continuous electric load mode for at least 17 days.

The recorded seismic data, obtained from the geophone block 3 and the hydrophone 4 and converted into the digital format, are stored on the integrated nonvolatile flash memory drive 19 (herein also called a first memory unit) shown on FIG. 3, installed on the recorder board 12 and linked with the microcontroller 18, having a capacity of 8 Gb, for example, providing autonomous operation of the bottom module at continuous recording on four channels from 2 days up to 1 month in various frequency ranges, taking into account that the higher is the upper bound of operation frequency range, the greater information volume has to be stored on the flash memory and the shorter would be the period of autonomous operation of the bottom module.

The digital compass 6 is used for determination of the system positioning in space. For this purpose, e.g. Honeywell HMR 3300 compass-inclinometer can be used, providing the following range of measured angles: azimuth is 360 degrees, trim and roll are +\−60 degrees from the vertical line, and accuracy of the angle measurements is +/−2 degrees.

The registration device (not shown on FIGS. 1-3) is intended for recording the seismic signals, according to a program mode. It is placed above the geophone block 3 and connected with the registration and control unit 10. For this purpose, any known device of this kind can be utilized in similar bottom modules and providing, for example, the following parameters reflected in Table 1 below:

TABLE 1
Registered frequency ranges, Hz

| | |
|---|---|
| The first | from 0.01 up to 100 |
| The second | from 0.01 up to 200 |
| The third | from 0.01 up to 400 |
| The fourth | from 0.01 up to 800 |
| The fifth | from 0.01 up to 1600 |
| Data sample ranges, according to the frequency | 0.25-4 |
| ranges, ms | |
| Instantaneous dynamic range, dB, no less than | 120 |
| ADC capacity, sigma-delta type, bit | 24 |
| Programmed gain coefficients | 1; 2; 4; 8; 16; 32; 64 |
| Effective noise level range, depending on the | from 0.08 up to 3. |
| registered frequency range and the gain | |
| coefficient, microV | |
| Inherent noise level | no more than 1%. |

Operation of the bottom module is carried out using the clock signal quartz generator 11 (herein also called a ‘set up generator’ in the drawing), playing the role of an internal clock of the module, for which a known temperature-controlled quartz generator can be used, e.g., MX07/R-X59S3S-8,19 with a temperature frequency instability (deviation) +/−5*10−9 manufactured by “Magic Xtal Ltd” (Omsk, Russia).

The status indicator 7, used in the bottom module for reporting on the current operation condition of the module and on the parameters of the power supply unit, can be made, for example, on the basis of a dichromatic LED sealed with a suitable compound. As the indicator is placed outside the case of the bottom module, it allows informing the user about the operation mode and state of the bottom module without opening the hermetic case.

The electric hermetic connector 8 is designed for connection of the onboard equipment to the bottom module without opening of the hermetic case 1. When the external devices 22 are disconnected, the connector 8 is closed with a lid, thereby allowing this unit to function on the depth up to 500 meters.

During the exploitation process, the bottom module can be located both on a water area bed (just during the seismic surveys) and on the deck of any waterborne vehicle including small size vessels, pontoons, etc. In case the bottom modules are located on board of a waterborne vehicle (vessel), they should be installed in transportation cells of a proper technological case, providing a reliable fixation thereof during stormy weather. Moreover, a kit of the onboard devices must be present on the vessel, and a high speed local network has to be arranged between the bottom modules and the onboard devices for initialization, seismic data gathering, and storage of seismic information.

### Operation of the Inventive Bottom Module

The inventive bottom modules operate as follows. The bottom modules are pulled out of the transportation cells and tied to a proper rope, and then submerged on the seabed (bottom ground of the water reservoir) under the action of gravity force. A reliable coupling between the bottom module and the ground is ensured after reaching the bottom ground, because of the distinctive features of the inventive module, namely: the cylindrical shape of the case with roundings at the case bottom and the lid that provide a reliable junction of the case with the bottom ground, disregarding the ground's composition and its relief. While being in the operating condition, as well as during a long term storage of the bottom module, a lowered air pressure of about 0.1 atm should be kept in the interior of hermetic case 1 that will provide a predeterminedly low moisture inside the case 1. This operation is made through the vacuum port 9. After the cover plug is removed from the port 9 and air is pumped out from the interior of the hermetic case 1, the vacuum port 9 is closed with the same cover plug.

Receiving the components of ground waves (vibrations) is carried out by geophone-type sensors (along three orthogonal X, Y, Z directions) of the geophone block 3 and the hydrophone 4. Seismic analog signals from X, Y, Z channels of the geophone block 3 are fed into the recorder board 12 simultaneously with an analog signal of hydrophone 4. The analog signals come through four separate identical channels X, Y, Z, and H. At that the hydrophone signals are fed into the preliminary amplifier 14 placed on the recorder board 12, which is caused by the necessity of equalizing the amplitudes of geophones and hydrophone signals, because the hydrophone signal is about 40 times lower than the geophone signals.

The analog signals from every channel are inputted into the programmable analog amplifier 15, whose gain coefficients are programmably set. The analog signals, having been amplified, are fed into the analog-to-digital converter (ADC) 16. In preferred embodiments of the present invention, the user is enabled of pre-setting the gain coefficients for every channel. For instance, during the setting of the recording parameters, the user can choose the gain coefficient for any channel from the following sequence: 1; 2; 4; 8; 16; 32; 64. The amplified signal is transferred to the ADC unit 16, wherein it is digitized by the 24 capacity ADC and then is passed to the ‘low pass filter’ 17 (digital low frequency filter), which is programmed with low-frequency filter hardware algorithms, for example, for 5 broadband values: 100, 200, 400, 800, 1600 Hz, which are correspondingly strictly linked with the signal discrete frequency rates: 250, 500, 1000, 2000, 4000 Hz. The digital low-frequency filter 17 receives seismic data in the digital format from the analog-digital converter 16; while the output of the digital low-frequency filter 17 is fed into the first microcontroller 18, using serial code arranged as bit sequences of seismic data from every channel X, Y, Z, H. The first microcontroller 18 is capable of:—conversion of the bit sequences into a byte-page format,—recording the converted seismic data into the first memory unit 19, and—synchronizing operations of the recorder board 12 with the clock signal generator 11. For the process of digitizing the analog signals, the operator predetermines a quantum period for the bit sequences through programmable means. The quantum period determines a time step, expressed in the digital format, for recording the voltage amplitude associated with seismic vibrations obtained from the geophone and hydrophone. The quantum period is preset during setting the bottom module for recording, and is based on an estimated frequency of seismic signals.

From the low-frequency filter output of every channel, the signal is fed into the microcontroller 18, using serial code arranged as a bit sequence. It is known that, in the shallow water conditions, at multiple reflections, a phase lag can occur between the pressure and the speed of a longitudinal wave during the recording of seismic signals within the operative frequency range. In connection therewith, for suppression of ‘noise-waves’, the signals from the adjacent channels fed to the microcontroller, are shifted by phase from one another by 0.25 of the quantum period, which allows for increasing the noise immunity (protection) of the bottom module, and providing operation in shallow waters and transition zones without any reduction of measurement quality. The microcontroller 18 converts the bit sequences from every channel in a byte-page structure and records this information into the memory unit (flash drive) 19, made, for example, in the form of two nonvolatile microchips with 8 Gb of the total memory capacity.

Besides, the microcontroller 18 provides for operation of the recorder board components synchronously from the clock signal generator 11, having the generation frequency of 8,192 MHz, ensuring the signal discrete rate. The signal with frequency of 8,192 MHz from the clock signal generator is fed into the recorder board 12.

Except the conversion and recording of the registered seismic data into the internal memory with its linkage to the reception time, preferably gotten from the GPS receiver, all other operations performed by the bottom module are executed under control of the interface board unit 13, supplied with the separate powerful microcontroller 20. During operation of the bottom module directly on the survey area, only the recorder board 12 is active, providing the conversion and recording of seismic data into the internal memory. At that time the interface board 13 is being in a standby mode, with minimal power consumption.

After the bottom module finishes the survey, the interface board 13 provides for interaction of the bottom module with the external devices and onboard devices 22. The main functions of the interface board 13 are:
reading the seismic data by the microcontroller 20 received from the flash drive 19 by means of the microcontroller 18 and transmitting the seismic data to the external devices 22;
reading by the microcontroller 20 the angle measurements from the digital compass, storing thereof in the internal memory (the memory unit 21), and transferring the angle measurement data to the external server;
indication of the bottom module state; at that the indication is initialized by request from the geophones of geophone block 3; the geophone's signal is fed into a formation circuitry, being part of the clock signal generator, which formation circuitry transmits a corresponding control signal to the interface board 13; then the indicator unit 7 subsequently displays data on the current condition of the bottom module by illumination or in another form employed in compact devices of this particular type; and
control of the charge state of the power supply unit 5 and managing the recharging process by means of a special controller installed therein.

During operation of the bottom module in the survey area, the synchronization of the module's equipment is provided by signals passed from a GPS or GLONASS receiver, e.g. of the Garmin type, wherein the receiver's output is connected with a hardware-software synchronizer included in the microcontroller 20 of the interface board 13.

Power supply of the bottom module is provided from the power supply unit 5. Voltage of about 7V is fed into the interface board 13 and further into secondary voltage converters 1.8V, 3.3V, being part of the interface board, for power supply of digital chips, and 5V for power supply of analog circuitries. Charging the rechargeable batteries of the power supply units is carried out without opening of the hermetic case 1, through the electric hermetic connector 8.

Connection of the external and the onboard devices 22 to the bottom module is arranged through the electric hermetic connector 8, performed on the outer surface of case 1, and protected by the damping (shock absorbing) elements 2 during operation, while acquiring the seismic data.

After finishing the operations and the geological stage of work, the bottom module is lifted up on the board of the vessel by means of a halyard. The maximal period of work of the bottom module is limited basically by the time of autonomous operation of the power supply unit, and also by a limited capacity of the flash memory drive. Thereafter, the bottom module is connected by hermetic connectors to the onboard module, and the gathered data is read from the bottom module's memory for further processing.

### Advantageous Industrial Applications of the Inventive Bottom Module

According to the present invention, the above-described case shape and its compact dimensions allow for installation and deployment of the bottom module on the seabed ground of any kind of composition and density, providing for reliable coupling thereof that increases the noise immunity and accuracy of seismic data recorded, and also broadens the scope of application of the inventive bottom module.

Implementation of the control and recording unit 10 based on the four-channel recorder board 12 and the interface board 13 operating under control of the microcontrollers 18 and 20 respectively, and connected with the clock signal generator 11, allows for optimizing the processing of registered data received from the geophone block 3 and hydrophone 4 with a separate preliminary signal processing for each channel according to the pre-installed computing program or based on control signals, which also allows for raising the noise protection of the bottom module and therefore for exploitation thereof in shallow waters and on the land in conditions of multiple reflections of the seismic signals, thereby providing a possibility of forming a seamless seismic section on the border of land and conjugated shelf water areas. The compact design of the inventive bottom module features a simple arrangement of equipment, providing for both: easy access to replaceable elements of the bottom module during exploitation thereof, and a simple way of assembly of the bottom module.

As mentioned above, the bottom module contemplates the following features: the geophones, the indicator, the hermetic connector placed on the outer surface of the case that is supplied with protective damping elements preventing the external parts of the module and the most vulnerable parts of the case from mechanical impacts. It also features a compact placement of the above-described equipment inside the case, which provides for highly efficient use thereof in surveys with a small step of location of the bottom modules on the seabed ground, wherein the modules are fixed with the help of halyard. This, in turn, allows for avoiding utilization of anchor ballast and the use of hydro-acoustic equipment for detection of the module at emerging thereof at the end of work, which ensures high measurement accuracy due to a denser placement of the bottom modules on the seismic profile. As noted above, the improved signal processing with increased noise protection and small dimensions of the inventive bottom modules allows for employment thereof in deep and shallow waters, which is very important in seismic survey and considerably broadens the scope of applications of the inventive bottom module for seismic research and measurement tasks, including seismic surveys conducted on the border of land and conjugated shelf water areas.

### LIST OF REFERENCES

[1]. Russian Federation Certificate of Useful Model No. 224890.

[2]. Deep water self-emerging bottom seismic system OBS-8/Soloviev S. L., Kontar E. A., Dozorov T. A., Kovachev S. A.//Proceedings of the USSR Academy of Sciences Physics of the Earth, 1988, No. 9, pp. 459-460.

[3]. Ocean Bottom Seismometer (OBS) Systems. Company Profile/Project Companies Kieler Umwelt und Meerestechnik GmbH (K.U.M.), Signal-Elektronik und Nets Dienste GmbH (SEND), April 2002, 11 p.

[4]. Russian Federation Certificate of Useful Model No. 228778.

[5]. Modern bottom systems for seismic survey and seismological monitoring/Zubko Y. N., Levchenko D. G., Ledenev V. V., Paramonov A. A.//Scientific instrument engineering, 2003, volume 13, No. 4, pp. 70-82.

We claim:

1. A seismic survey system including at least one bottom module and a number of onboard devices located on a vessel, said bottom module is capable to be submerged from said vessel onto a bottom ground of a water reservoir and lifted up on the board of said vessel; said bottom module comprising:
a hermetic case;
a hydrophone mounted substantially on the outer surface of said case;
a geophone block mounted substantially on the outer surface of said case;
a vacuum port mounted on the outer surface of said case, said vacuum port is used for pumping out air from the inner space of said case;
a hermetic electrical socket, in particular, connecting said bottom module to said onboard devices, said hermetic electrical socket is mounted on the outer surface of said case;
a power supply unit mounted inside of said case, and capable of being charged through said hermetic electrical socket;
equipment arranged inside said case, said equipment is powered substantially from said power supply unit, said equipment including:
a clock signal generator;
a digital compass;
a recording and control unit that includes:
a recorder board furnished with a first microcontroller, and
an interface board furnished with a second microcontroller linked with the first microcontroller;
said recorder board and said interface board are connected with said clock signal generator; the recorder board is connected with the geophone block;
the interface board is connected with the digital compass; the clock signal generator is connected with the geophone block; and
wherein the interface board is connected with said power supply unit, and the recorder board is connected with said hydrophone.

2. The seismic survey system according to claim 1, wherein said recorded board further includes:
means for amplifying seismic data received substantially from said geophone block and said hydrophone, and
a first memory unit for storage of the seismic data received from said means for amplifying;
and wherein
said interface board is connected with a status indicator; said interface board further includes a second memory unit connected with said second microcontroller; said second microcontroller is capable of:
reading the seismic data received from the first memory unit via the first microcontroller and transmitting the seismic data to said onboard devices;
receiving, processing, and storage into said second memory unit of values of measured angles, received from said digital compass;
indicating the state of said bottom module upon an operator's request through the status indicator;
control of the state of the power supply unit and of the process of recharging thereof;
providing a possibility of switching said bottom module into a minimal power consumption mode during survey operations.

3. The seismic survey system according to claim 1, wherein said geophone block represents a right-hand orthogonal system, which measures three components of a displacement vector {X,Y,Z}: a vertical Z-component and two mutually perpendicular horizontal X,Y-components, wherein the X component is associated with the readings of said digital compass; and wherein said hydrophone measures an H-component.

4. The seismic survey system according to claim 3, wherein said recorder board includes three separate identical channels for connection with the geophone block, and one channel for connection with the hydrophone; said channels provide for receiving, processing, and recording the seismic data of said X, Y, Z, and H components of both longitudinal and transversal waves.

5. The seismic survey system according to claim 4, wherein said recorder board includes:
a programmable amplifier for receiving the seismic data essentially via said channels for connection with the geophone block and via said channel for connection with the hydrophone, and further amplifying said seismic data; and
an analog-digital converter capable of receiving said seismic data amplified by the programmable amplifier, and transforming thereof into the digital format.

6. The seismic survey system according to claim 5, wherein said programmable amplifier is capable of choosing and saving a gain coefficient for each said channel; said programmable amplifier further includes a preliminary amplifier for connection with the hydrophone; said preliminary amplifier is capable of:
receiving the seismic data of said H-component from the hydrophone, and
preliminary amplifying the seismic data of said H-component.

7. The seismic survey system according to claim 6, wherein said recorder board further comprises:
a first memory unit; and
a digital low-frequency filter receiving said seismic data in the digital format from said analog-digital converter, the output of said digital low-frequency filter is fed into the first microcontroller, using serial code arranged as bit sequences of seismic data from every said channel;
wherein
said first microcontroller is capable of:
conversion of said bit sequences into a byte-page format,
recording the converted seismic data into said first memory unit, and
synchronizing operations of the recorder board with said clock signal generator.

8. The seismic survey system according to claim 7, wherein said bit sequences from adjacent said channels are fed into the first microcontroller with a predetermined phase shift relatively one another.

9. The seismic survey system according to claim 8, wherein said predetermined phase shift is set as 0.25 of a quantum period programmably preset for said bit sequences.

10. The seismic survey system according to claim 1, wherein
said case is shaped as a cylindrical hermetic case having: a lateral surface, a flat bottom, a bulging upper lid, and radial rounding of the lateral surface in the area adjacent with the bottom; and
said bottom module further comprises a number of damping elements outwardly placed on the lateral surface for protection external elements of said bottom module from mechanical impacts.

11. The seismic survey system according to claim 1, wherein said bottom module further comprises a status indicator outwardly placed on the case and connected with the interface board.
